(19) United States
(12) Patent Application Publication
(10) Pub. No.: US 2009/0302019 A1
(43) Pub. Date: Dec. 10, 2009

(54) Apparatus and Method for Vaporizing Volatile Material

(76) Inventors: Tim Selenski, Regina (CA); Jason Cook, Regina (CA)

Correspondence Address: ADE & COMPANY INC., 2157 Henderson Highway, WINNIPEG, MB, R2G1P9, CA

(21) Appl. No.: 12/478,937

(22) Filed: Jun. 5, 2009

Related U.S. Application Data
(60) Provisional application No. 61/058,960, filed on Jun. 5, 2008.

(51) Int. Cl. H05B 3/00

(52) U.S. Cl. 219/201; 219/482

(57) ABSTRACT

A volatile material vaporizing apparatus features a heating element and heating element controls supported in separate housings to avoid exposure of the controls to heat produced by the heating element. Another embodiment features an elongate heating element supported entirely within a housing having an open end sized to fit over the bowl of an existing smoking device so that drawing air through the smoking device induces airflow into an inlet opening of the housing, along the heating element disposed therein, and onward to the smoking device. In another embodiment, a housing includes a plug portion slidable into a cigarette lighter socket of a vehicle to establish connection with electrical contacts therein. A heating chamber opposite the plug portion is in fluid communication with a heating element in the housing, and an inlet opening allows airflow into the housing for flow along the heating element into the heating chamber.

This application claims benefit under 35 U.S.C. 119 of U.S. Provisional Patent Application Ser. No. 61/058,960, filed Jun. 5, 2008.

The present invention relates generally to inhalation of volatile materials vaporized and released from natural substances, and more particularly to vaporization of volatile materials for inhalation without combustion.

### BACKGROUND OF THE INVENTION

Within the art, it is known to use the process of vaporization of volatile materials contained within natural substances to enable inhalation of these materials without combustion to attempt to reduce detrimental health effects associated with conventional combustion-initiated smoking practices typically used to extract ingredients from substances such as medical cannabis, tobacco or other herbal products or smoking materials.

Several devices have been developed with this purpose in mind. Some such vaporization devices use an electrically operated heating element to heat air to a temperature suitable to vaporize the volatile material within the substance. Flow of this heated air through the substance achieves the vaporization of the volatile material therein to carry the so released materials to the user's mouth for inhalation to the lungs.

Some commercially available vaporizers make use of electronic circuitry to give the user control over the temperature of the heating element, for example to allow for adjustment of the temperature to better match the temperature at which the volatile content of a particular substance will vaporize without releasing other unwanted materials that only volatize at higher temperatures. One problem that may arise is that close proximity spacing between the current controlling circuit board the heating element fixed thereto for control thereby may result in damage to the circuit board resulting from discharged heat. Typically, electrical connection between the heating element and the controls is hard-wired, often resulting in a need to send in the device away for repair or replace the entire device should one of these two components fail or need replacement.

Attempts to produce a compact vaporization unit, at least one commercially available product has been produced with an exposed heating element that may have detrimental effects on safety and may require extremely close proximity to the substance to be vaporized to achieve sufficient heating thereof when used to attempt vaporization in the bowl of an existing smoking device, which may increase the likelihood of inadvertently burning the substance by contact with the heating element. Another commercially available handheld unit is not intended for use with existing smoking devices, but requires partial disassembly to refill the unit and may be quite limited in the amount of substance it can contain, perhaps leading to a need for multiple refills to release a desirable amount of volatile material. Other portable units have been produced that rely on a separate flame source for heating of the substance indirectly through a glass body and thus may also increase the risk of burning rather than vaporizing.

### SUMMARY OF THE INVENTION

According to a first aspect of the invention there is provided a volatile material vaporizing apparatus comprising:

a heat device comprising:
a first housing;
an elongate heating element supported within the first housing; and
a first connection component carried with the first housing in electrical communication with the heating element and accessible from outside the first housing; and

a control device comprising:
a second housing;
controls supported within the second housing and operable to control operation of the heating element when electrically connected between the heating element and a power source; and
a second connection component carried with the control module in electrical communication with the controls;

the first and second connection components being detachably matable together to selectively establish selective electrical connection of the controls to the heating element with the controls and heat element spaced apart from one another.

Preferably the second housing is physically separated from and situated outside the first housing.

Preferably at least one of the detachably matable connection components comprises a connector mounted on an externally insulated conductor extending outward from a respective one of the housings to facilitate electrical connection of the heating element and the controls with the first and second housings spaced apart one another.

Preferably the externally insulated conductor comprises a flexible cable.

Preferably the detachably matable connection components comprise a matable plug and socket.

Preferably the controls are operable to control a temperature of the heating element when electrically connected thereto.

Preferably the controls comprise a circuit board.

According to a second aspect of the invention there is provided a volatile material vaporizing apparatus for use with an existing smoking device comprising a bowl for receiving volatile material and a mouthpiece for drawing air through the bowl, the apparatus comprising:

a heat element housing; and

an elongate heating element supported within the housing and arranged to connect to a power supply for operation, a full length of the heating element being disposed within the housing between a support end thereof proximate which the heating element is arranged to connect to the power supply and an open end opposite the support end;

the housing having at least one inlet opening therein at a distance from the open end past a free end of the heating element nearest the open end of the housing to facilitate passage of air into the housing for flow along the heating element by drawing of air through the open end; and

the open end of the housing being sized to fit over the bowl of the smoking device facilitate such that drawing of air through the mouthpiece of the smoking device by a user induces airflow into the inlet opening of the housing, along the heating element within the housing, through the open end of the housing and through the bowl and mouthpiece to the user.

Preferably the support end of the housing is defined by a handle portion of the housing, the heating element extending into an airflow portion of the housing at which the at least one inlet opening is defined, the airflow portion being closed off from the handle portion around the heating element and being open at a distal end opposite the handle portion to define the open end of the housing.

Preferably the housing flares outward to increase in size toward the open end thereof.

Preferably the housing deviates from a longitudinal axis along which the heating element extends at a point beyond the heating element toward the open end of the housing so as to open about an axis traversing the heating element.

Preferably the axis about which the open end of the housing opens is generally perpendicular to the longitudinal axis along which the heating element extends.

Preferably the housing comprises glass.

Preferably the housing comprises an inner enclosure disposed within an outer enclosure, the inner enclosure extending about the heating element over at least a partial length thereof, an air passage fluidly communicating the opening in the housing with an interior of the inner enclosure to allow air to reach the heating element.

Preferably the opening and the air passage define a linear path from outside the housing to the interior of the inner enclosure.

Preferably the inner enclosure extends about the heating element at the free end thereof and along the heating element from the free end thereof.

Preferably the heating element is exposed to an exterior environment surrounding the housing along a linear path through the opening in the housing.

Preferably the apparatus is used in combination with the existing smoking device.

According to a third aspect of the invention there is provided a method of vaporizing volatile material, the method comprising:

providing a vaporizing apparatus comprising a housing having an elongate heating element supported therein to extend therealong between a support end of the housing and an open end of the housing opposite the support end;

providing a smoking device comprising a bowl and a mouthpiece connected thereto;

placing herbal material within the bowl of the smoking device;

electrically connecting the heating element of the vaporizing apparatus to a power supply;

placing the open end of the housing of the vaporizing apparatus over the bowl of the smoking device; and

inhaling through the mouthpiece of the smoking device to thereby draw air into the housing of the vaporizing apparatus through an inlet opening therein, along the heating element within the housing, through the open end of the housing and through the bowl of the smoking device into the mouthpiece.

According to a fourth aspect of the invention there is provided a volatile material vaporizing device comprising:

a housing comprising an elongate plug portion shaped and sized to allow axial sliding thereof along a longitudinal axis of the housing into a cigarette lighter socket of a vehicle;

electrical connections supported at the plug portion of the housing to define electrical contacts situated externally thereat to establish electrical contact with positive and negative contacts in the cigarette lighter socket under sufficient sliding of the plug portion thereinto;

a heating chamber defined at an end of the housing opposite the plug portion for receiving volatile material to be vaporized by heat from the heating element;

an elongate heating element supported within the housing between the heating chamber and an end of the plug portion thereopposite in electrical communication with the electrical contacts to extend along the longitudinal axis of the housing; and

an inlet opening in the housing and an outlet opening between the housing and the heating chamber defined thereon to allow airflow into the housing through the inlet opening for flow along the heating element into the heating chamber.

There may be provided a material holder sized and shaped to be removably insertable into the heating chamber to support volatile material therein in fluid communication with the opening between the heating chamber and the housing.

### BRIEF DESCRIPTION OF THE DRAWINGS

In the accompanying drawings, which illustrate exemplary embodiments of the present invention:

FIG. 1 is a schematic side view of a vaporizer according to a first embodiment of the present invention illustrating use thereof with an existing smoking device.

FIG. 2 is a schematic side view of the first embodiment vaporizer of FIG. 1 with a housing thereof cut away for illustration of its interior.

FIG. 3 is a schematic side view of a vaporizer according to a second embodiment of the present invention.

FIG. 4 is a schematic side view of a vaporizer according to a third embodiment of the present invention.

### DETAILED DESCRIPTION

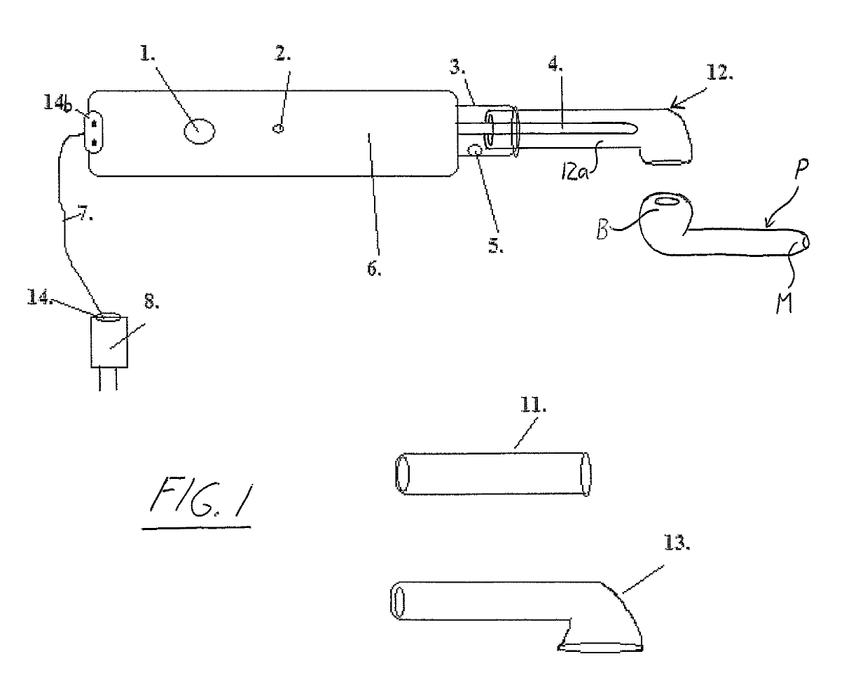

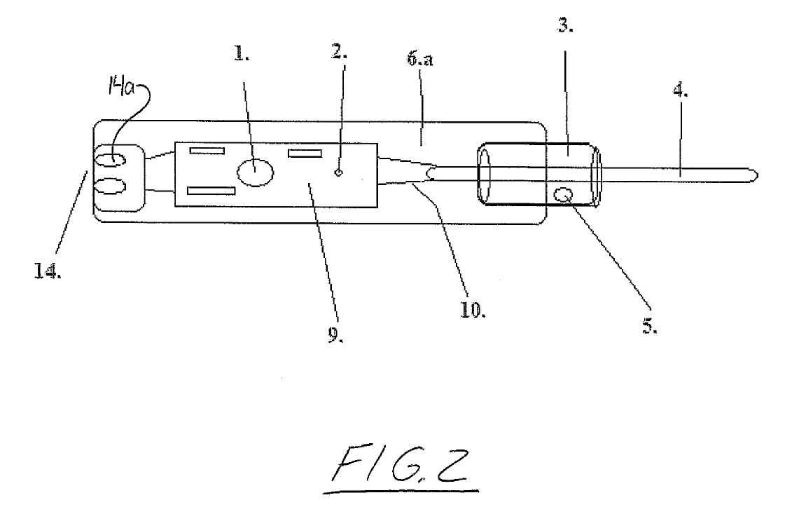

FIG. 1 shows an exterior of a first embodiment vaporizer lighter having a handle body 6 which may be made of any of a variety of suitable materials including high performance plastic composite resins, ceramics, titanium or other metals, wood, glass or any combination thereof. The handle body 6 houses a temperature control unit with power on/off ability and temperature control provided by one or more pushbutton, rotational knob or other type of switch 1 operable at the exterior of the handle body 6. A power cord 7 provides electrical wiring which may be releasable from one or both of the handle body 6 and a power source plug 8 by way of an optional cord detaching connector 14. The plug end 8 may be of a type engagable with a conventional North American 110V household outlet, but is not restricted to any particular voltage source. For example, the plug may be of various types suitable for household outlets which vary globally in plug and socket shapes and configurations and voltages. An operational Indicator light 2 visible at the exterior of the handle body 6 shows whether the unit is on or off. As shown in FIG. 2, attached to a circuit board 9 of the control unit is an elongate heating element 4, which may for example be composed of a ceramic, metal or light bulb filament type structure. The heating element 4 is protected and incased by a glass adapter holder 3 mounted at an end of the handle body 6 opposite its connection with the power cord 7. Outside the handle body 6 past the end thereof opposite the power cord 7, the glass adapter is provided with an inlet air hole 5 in its periphery allowing air to enter its interior and contact the heating element 4.

FIGS. 2 shows an exposed view of the handle body's interior, 6a detailing the installation of known basic circuitry 9 attached to heating element 4 for controlling operation of the heating element 4. The connection 10 between the circuitry 9 and the heating element may be hard wired or detachable from at least one of these two components, much like the optional cord detach 14 of the power cord 7. This exposed close up of the handle body 6 also shows the glass adapter holder 3 mounted in the handle body 6 proximate the end thereof opposite the power cord 7 to project outward therefrom along and around the heating element 4. Mounting of the glass adapter holder 3 may be effect by any of various support arrangements and materials including, without limitation to, silicon, screws, and molded plastics, and it will be appreciated that although made of the glass in this embodiment, the adapter holder may be made of other materials, including ceramics, titanium or other metals and other materials. The element 4 extends away from the circuitry 9 coaxially along the interior 6a of the generally cylindrical hollow handle body 6 to enter the generally cylindrical hollow glass adapter holder 3 and at the end thereof disposed coaxially within the handle body 6 to extend coaxially through the adapter holder 3 and project through the distal end thereof opposite the handle body 6. All interior components, like the circuit board 9 and the portion of the detachable power cord connection 14 installed on the handle body 6, may be fastened in place using any of a variety of known supporting arrangements and materials including, without limitation to, silicon, screws and molded plastics.

As shown in FIG. 1, an adaptor piece 12 made of glass, titanium or other metals, ceramic or any other suitable material known to those of skill in the art is mounted permanently to the handle body 6 or detachably by means of a joint, press fit, glass taper joint or other connection at the distal or front exposed end portion of glass adaptor holder 3 situated outside the handle body 6. The adapter piece 12 has a hollow cylindrical stem 12a which coaxially connects with the hollow cylindrical adapter holder 3 to extend past the free end 4a of the heat element 4 before the adapter piece 12 bends or curves towards its distal end opposite the adapter holder 3 to position an open end 12b of the adapter piece 12 in a position facing laterally away from the cylindrical stem 12a. The passage or conduit defined through the adapter piece 12 thus extends linearly along the heat element 4 then bends through ninety degrees to open about an axis perpendicularly transverse to the longitudinal axis of the stem portion 12a.

With the glass adaptor holder 3 sealed around the heating element 4 at its inner end supported within the handle body 6, for example by ceramic beading, ceramic washers or a tight fit of the glass around the heating element, the vaporizer can be used with an existing smoking device, such as pipe P of FIG. 1, by warming up the heating element 4 then lowering the open end 12a of the adapter piece 12 over a bowl B of the pipe containing the volatile material containing substance to be vaporized. With the open end 12a positioned over the similarly sized bowl B, preferably in sealing or close to sealing direct contact with the pipe P around the bowl B, a user inhales through the mouthpiece M of the pipe P. This draws air into the adapter holder 3 through the inlet air hole 5 and onward along the heating element 4 through the stem 12a of the adapter piece 12. This air is heated as it passes over and along the heating element 4 to a temperature sufficient to vaporize the volatile material of the substance packed in the bowl B of the pipe P as the air is drawn through the bowl B into the mouthpiece M via the open end 12b of the adapter piece 12 for inhalation by the user.

As shown in FIG. 1, adapter pieces of different sizes and shapes may be installed on the adapter holder 3, for example to provide a larger laterally opening end of the vaporizer as shown by alternate adapter 13 for use with a smoking device having a larger bowl or to instead provide an axially opening end on the vaporizer as shown by alternate adapter 11 having a purely cylindrical shape defining a linear passage or conduit through it between its opposite open ends. The aforementioned adaptor pieces may be used in conjunction with any existing smoking devices including pipes and water pipes, but may also be used with whip or hose style attachments, thus transforming existing “smoking” devices into “vaporization” devices. The air intake hole 5 in the glass adaptor holder 3 can be used to pass the end of a cigarette therethrough for contact with the heating element 4 for use as an igniter or lighter, providing a cleaner healthier alternative to use of conventional flame devices currently available, and possibly similar advantages over devices using metal heating elements when a ceramic heating element is instead used. It will be appreciated that more than one air intake hole 5 may be included at different positions along or around the heating element 4 and may instead or additionally be provided in the handle body 6 in embodiments where the inner end of the adapter holder 3 is positioned within the handle body 6 is not closed off around the heating element.

In the first embodiment, the heating element 4 is disposed entirely within a housing defined by the handle body 6, adapter holder 3 and adapter piece 12 to close about the elongate heating element over its full length. The open end 12b of the adapter piece 12 is situated past the free end of the heating element opposite its supported end at its connection 10 to the control circuit 9 and the air inlet opening 5 is small in diameter or size to prevent accidental contact with the heating element 4, for example by passage of a fingertip through the inlet into the interior of the adapter holder 3 of the housing. The air inlet opening may for example be approximately ¼-inch wide and may for example be circular or have an elongate slot-like shape, for example up to three inches long where the component in which the air inlet opening is formed is sufficiently large. The described enclosed structure S thus allows use of the device with existing smoking devices, specifically by drawing air heated within the vaporizer into the smoking device from the vaporizer, but avoids the use of an exposed element that may cause accidental burns to a user or object or unwanted combustion of herbal materials by inadvertent contact with the element. It will be appreciated that as an alternative to removable adapter pieces 11, 12, 13, the vaporizer may used a fixed construction closing around the heating element 4 over its full length to prevent any exposure of the heating element 4. In such embodiments, the adapter holder 3 and one adapter piece may be permanently attached together in a manually undetachable arrangement by the manufacturer or seller, or the adapter holder and adapter piece may be replaced by a single integral enclosure unit fixed to the handle body at one end, being open at the opposite end and having at least one intake air opening 5 between the end fixed to the handle body 6 and the free end of the heating element opposite the handle body.

Furthermore, the enclosure defined by the handle body 6, adapter holder 3 and adapter piece 12 may alternatively be defined by a single body. The enclosure, whether defined by a single or multiple interconnecting bodies, may have inner and outer cases or layers doubly enclosing around at least a portion of the heat element's length with annular space between them to reduce heat transfer to the exterior surfaces of the housing make the housing cooler to the touch and thereby better prevent accidental burning to the hand of a user or to a surface on which the vaporizer is placed. In such an arrangement, air inlet openings would be provided in both layers to facilitate airflow from outside the vaporizer to the interior space in which the heat element is disposed. Alignment of corresponding inlet holes in the inner and outer layers along and around the housing would ensure a linear path or passage defined extending toward the heating element from outside the housing to allow for passage of a cigarette therethrough for ignition by the heat of the element.

The detachable electrical connection 14 between the control circuit 9 and the power cord 7 comprises a first connection component 14a mounted within the handle body 6 in electrical communication with the control circuit 9 at an end thereof opposite the heating element 4 and a second connection component 14b mounted at an end of the power cord 7 opposite the power source 8. The two connection components use a cooperative plug and socket matable together in a known manner that establishes electrically conductive contact between them to electrically connect the power source and the control unit and are manually releasable and manually reengagable for quick connection and disconnection. The handle body 6 has openings to communicate the first connection component 14a with the external environment surrounding the handle body 6 to facilitate access to the first connection component 14a by the second connection component 14b from outside the handle body 6. A similar detachable connection 14 between the power source plug 8 and power cord 7 may be used to facilitate the use of different plug types, including any necessary converter or transformer, depending on the location of use. Sources other than household electrical outlets capable of providing sufficient power to bring the element 4 to a suitable temperature for vaporization for be used. For example, a plug adapted for use with a vehicle cigarette lighter socket may be used at the power source end of the cable or a battery, incorporated into the handle body 6 or connected thereto by a power cord, may be applicable.

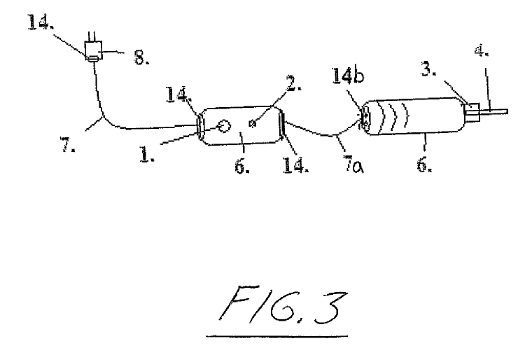

FIG. 3 shows a second embodiment vaporizer lighter which operates in the same manner as the first embodiment vaporizer of FIGS. 1 and 2 and provides the same advantages in terms of safety, compatibility with existing smoking devices and optional use a lighter or igniter. The second embodiment differs however in that the control unit, including the control knob or button(s) is carried in a second housing 6b located outside and separate from the handle body 6 that together with the adapter body 3 defines the first housing supporting the heating element 4 and closing about the longitudinal axis thereof.

In the second embodiment, the control unit and heating element 4 are thus supported within separate and distinct housings to define a control module or device and a heating module or device. The interior of the handle body 6 of the second embodiment thus differs from that of the first embodiment, as shown in FIG. 2, in that the connection 10 at the supported or base end of the heating element 4 establishes connection directly to the first electrical connection component 14a rather than to the control circuit 9, as the control circuit 9 is in the separate control module housing 6b in the second embodiment. A corresponding connector 14b matable with the first electrical connection component from outside the handle body 6 is carried on one end of another flexible conductive externally insulated cable or cord 7a. This additional cord 7a is connected at its opposite end to the control unit within the control module housing 6b via a similar detachable electrical connection 14. The heating module of the second embodiment vaporizer lighter is thus free of all circuitry and removable therefrom by the use of detachable cord 7a.

The additional flexible cord 7a allows free relative movement between the separate control module and heating module housings within a limited volume of space. The housing of the control unit and the heating element 4 within two physically separate housings prevents damage to the control unit that may otherwise result from heating or malfunction of the heating element 4. The detachable connection between the two modules facilitates replacement of an old or defective heating element 4 by replacing the entire heating module, thereby eliminating the need to open or dismantle components to replace just the heating element 4 so that repair of the vaporizer lighter can be effected by the owner or user by simply purchasing a replacement heating module (consisting of handle body 6, heating element 4, electrical connection component 14a, and adapter body 3 for the illustrated second embodiment vaporizer/lighter) and plugging it onto the end of flexible cord 7a. This avoids the need to return the previously purchased equipment to the manufacturer or a repair center for replacement of an old or malfunctioning heating element, as is currently required for repair of at least one type of commercially available vaporizer.

Within the control module housing 6b at the end portion thereof opposite its connection to the handle body 6 via the additional cord 7a, the control unit 9 is adapted for connection to a power source in the same manner as described herein above for the first embodiment. It will be appreciated that the additional cord 7a need not necessarily have manually detachable electrical connectors at both ends, as being detachable from only one of the two modules would be sufficient. If manually detachable from the control module housing 6b but rigidly fixed to the handle body 6, then products sold as heating module replacements would include flexible cord 7a. Similarly, embodiments having the separate heating and control modules of the second embodiment but using a permanent enclosure around the heating element in place of the detachable adapter holder 3 and adapter pieces 11, 12, 13 would need to include such an enclosure in the sale of a replacement heating module.

As an alternative to the illustrated second embodiment vaporizer/lighter, the first embodiment handle body 6 could be modified to separately enclose the control circuit 9 and the heating element 4 within it to reduce the likelihood of damage to the control circuit. For example, an electrically and thermally insulative divider or barrier could be provided around the connection 10 between the control circuit 9 and the heating element 4 to divide the handle body interior 6a into two separate compartments, each considered to be the housing of a respective one of the heating and control modules. In this example, a manually detachable connection could be provided between the circuit board 9 and the connector 10, or between the connector and the heating element 4 to allow for user replacement of the heating element. However, the illustrated second embodiment using separate modules having distinct housings physically spaced apart from one another by a conductor 7a detachable from at least on of the housings further simplifies consumer-end repair by avoiding the need to open up any housing to replace the heating device, which also increases consumer-safety by avoiding exposure to any electrically conductive elements during such replacement.

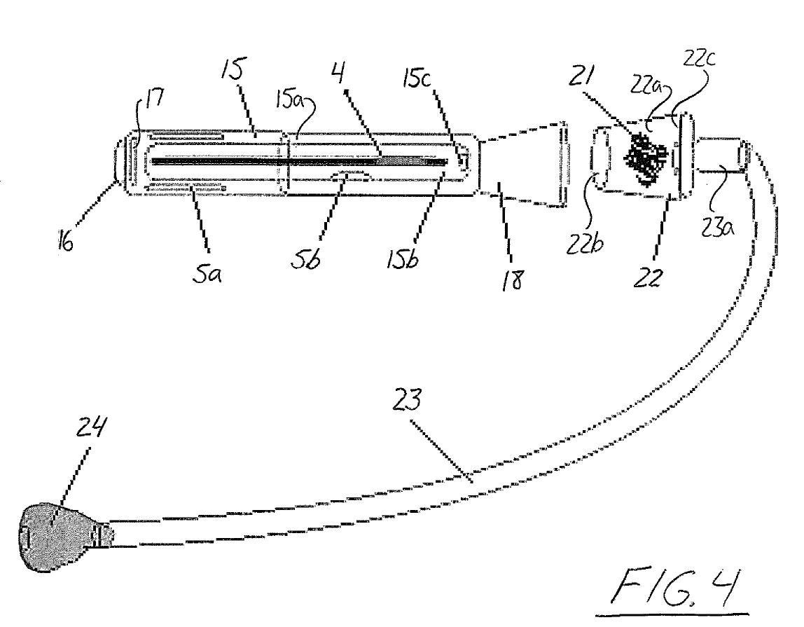

FIG. 4 shows a third embodiment vaporizer adapted for powering by the cigarette lighter or accessory power socket of an automobile. The third embodiment features a cylindrically shaped glass housing 15 extending along an elongate central axis around which it closes, the diameter of the cylindrical housing's circular cross section being sufficient small to allow sliding of the housing 15 axially into the hollow cylindrical sleeve on a conventional automobile cigarette or power socket. A central electrically conductive contact 16 projects outward from one end of the cylindrical housing 15 to establish electrical contact with the corresponding center contact centrally located within the socket sleeve of the automotive lighter socket under sufficient sliding of the housing 15 into the socket. Inside the housing 15, the central contact 16 is connected to an elongate heating element extending along the central axis of the housing 15 toward an end thereof opposite the central contact 16 in an electrically conductive manner. The heating element is also electrically linked to peripheral electrical contacts 17 projecting outward from the periphery of the cylindrical housing proximate the end thereof from which the central contact 16 axially projects, these peripheral contacts being dimensioned for or biased into contact with the cylindrical sleeve of the socket defining the other contact in the automotive lighter socket when the contact end of the housing 15 is slid thereinto. The end portion of the cylindrical housing on which the contacts are supported thus defines a plug portion sized for insertion into the automotive lighter socket and adapted to establish electrical communication therewith under such insertion.

At an end of the cylindrical housing 15 opposite the end thereof supporting the electrical contacts 16, 17, just past the free end of the heating element 4 opposite its connection to these contacts, a heating chamber 18 having a frustoconical interior shape projects axially from the cylindrical housing, widening away therefrom. A container or material holder 22 has a peripheral wall 21a with a frustoconical shape tapering at the same slope as the frustoconical heating chamber and having outer dimensions equal or slightly less than the inner dimensions of the chamber 18 so as to be slidable thereinto for seating against the bottom of the chamber 18 formed at the end of the housing 15 from which it projects or the sloped interior surface of the chamber's peripheral wall. The narrow end 22b of the material holder 22 is open inside the peripheral wall 22a. The wider end 22c of the material holder 22 is capped off by a sealing cover through which an inlet piece 23a of a flexible inhalation hose or tube 23 extends into the interior of the material holder 22 within its peripheral wall 22a. The cover is sealed with the respective end of the material holder's peripheral wall and with the hose inlet 23a to allow airflow across the cover only through the hose inlet 23a. The inlet piece 23a is sealed to an end of the hose 23 in fluid communication therewith on a side of the cover opposite the material holder's peripheral wall. At an end of the hose 23 opposite the inlet 23a is a mouthpiece 24 through which a user can draw air by way of inhalation.

The housing features concentric inner and outer cylindrical glass enclosures 15a, 15b double encasing the heating element 4 to keep the temperature of the housing's outer surface relatively low to prevent burns when gripping the housing during or shortly after operation of the device. A first air intake opening 5a opens through the peripheral wall of the outer enclosure 15a in an elongated slot-like configuration extending along the housing 15 from proximate the connection end of the heating element 4 toward the opposite free end of the heating element over approximately one-third of its length. A second intake opening 5b is provided in the inner cylindrical enclosure 15b of the housing, opening through its peripheral wall in a round configuration at a position about one-third along the heating element's length from its free end. An opening 15c is left in the end of the inner enclosure 15b nearest the heating chamber 18, with the corresponding end of the outer enclosure 15a at which the heating chamber 18 is supported also being open, to thereby allow airflow between the interior of the housing's inner enclosure 15a, along which the heating element extends, and the interior of the heating chamber 18.

In use, the substance containing the volatile material to be vaporized and inhaled is placed into the material holder 22 which is subsequently inserted into the heating chamber 18 through the wider open end thereof in a wedged like fit generally flush against the inner surface of the heating chamber's peripheral wall. If not having previously been inserted into the automotive lighter socket, the housing 15 is so inserted to power the heating element 4 under electrical connection thereof with the automobile's electrical system via the electrical contacts in the socket and on the housing of the device. Once the heating element has operated sufficiently to reach a desired temperature, air is drawn through the user inhales over the opening of the mouthpiece 24 to draw air into the housing 15 through the first inlet opening 5a, further toward the central axis of the housing 15 within the inner enclosure 15b thereof through the second inlet opening 5b, along the heating element 4 past the free end thereof into the material holder 22 received in the heating chamber 18 through the open ends of the inner and outer enclosures 15a, 15b of the housing 15 S opposite the electrical contacts 16, 17, and onward through the tube or hose 23 for inhalation by the user. From the forgoing, it will be appreciated that the housing does not seal against the peripheral wall of the lighter socket, as it is spaced therefrom the projecting peripheral electrical contacts 17 when inserted into the socket, thereby allowing air to be drawn into the lighter socket in the annular space between the housing 15 and the socket wall. The heating of the air as it passes over and along the heating element 4 toward the heating chamber 18 raises it to a temperature sufficient to vaporize the volatile material of the substance in the material holder 22 while passing therethrough, so that the vapours released by this action are inhaled by the user through the mouthpiece of the hose 23.

Alternatively, the third embodiment vaporizer may be used without the hose attachment to simply release vaporized material into the surrounding environment. In such operation, the substance used may be inserted into the heating chamber directly or by placement into a hose-free material holder for subsequent insertion into the heating chamber 18. For example, the vaporizer may use an aromatherapy essential oil insert, for example a porous pad having had drops of an essential oil applied thereto from a commercially available supply jar or vial, to release a scent into the vehicle interior.

It will be appreciated that although not shown, the third embodiment vaporizer may be equipped with one or both of an on/off control to allow the vaporizer to remain in the lighter socket even when not in use and a temperature control to facilitate control over the level to which the element is heated. On the other hand, the vaporizer may be produced as a simple plug in unit designed to activate upon plugging into a powered lighter socket and to heat to a single predetermined level, and as such not feature any manually operable controls.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A volatile material vaporizing apparatus comprising:
a heat device comprising:
a first housing;
an elongate heating element supported within the first housing; and
a first connection component carried with the first housing in electrical communication with the heating element and accessible from outside the first housing; and
a control device comprising:
a second housing;
controls supported within the second housing and operable to control operation of the heating element when electrically connected between the heating element and a power source; and
a second connection component carried with the control module in electrical communication with the controls;
the first and second connection components being detachably matable together to selectively establish selective electrical connection of the controls to the heating element with the controls and heat element spaced apart from one another.

2. The apparatus according to claim 1 wherein the second housing is physically separated from and situated outside the first housing.

3. The apparatus according to claim 2 wherein at least one of the detachably matable connection components comprises a connector mounted on an externally insulated conductor extending outward from a respective one of the housings to facilitate electrical connection of the heating element and the controls with the first and second housings spaced apart one another.

4. The apparatus according to claim 3 wherein the externally insulated conductor comprises a flexible cable.

5. The apparatus according to claim 1 wherein the detachably matable connection components comprise a matable plug and socket.

6. The apparatus according to claim 1 wherein the controls are operable to control a temperature of the heating element when electrically connected thereto.

7. The apparatus according to claim 1 wherein the controls comprise a circuit board.

8. A volatile material vaporizing apparatus for use with an existing smoking device comprising a bowl for receiving volatile material and a mouthpiece for drawing air through the bowl, the apparatus comprising:
a heat element housing; and
an elongate heating element supported within the housing and arranged to connect to a power supply for operation, a full length of the heating element being disposed within the housing between a support end thereof proximate which the heating element is arranged to connect to the power supply and an open end opposite the support end;
the housing having at least one inlet opening therein at a distance from the open end past a free end of the heating element nearest the open end of the housing to facilitate passage of air into the first housing for flow along the heating element by drawing of air through the open end; and
the open end of the housing being sized to fit over the bowl of the smoking device such that drawing of air through the mouthpiece of the smoking device by a user induces airflow into the inlet opening of the housing, along the heating element within the housing, through the open end of the housing and through the bowl and mouthpiece to the user.

9. The apparatus according to claim 8 wherein the support end of the housing is defined by a handle portion of the housing, the heating element extending into an airflow portion of the housing at which the at least one inlet opening is defined, the airflow portion being closed off from the handle portion around the heating element and being open at a distal end opposite the handle portion to define the open end of the housing.

10. The apparatus according to claim 8 wherein the housing flares outward to increase in size toward the open end thereof.

11. The apparatus according to claim 8 wherein the housing deviates from a longitudinal axis along which the heating element extends at a point beyond the heating element toward the open end of the housing so as to open about an axis traversing the heating element.

12. The apparatus according to claim 11 wherein the axis about which the open end of the housing opens is generally perpendicular to the longitudinal axis along which the heating element extends.

13. The apparatus according to claim 8 wherein the first housing comprises glass.

14. The apparatus according to claim 8 wherein the first housing comprises an inner enclosure disposed within an outer enclosure, the inner enclosure extending about the heating element over at least a partial length thereof, an air passage fluidly communicating the opening in the housing with an interior of the inner enclosure to allow air to reach the heating element.

15. The apparatus according to claim 14 wherein the opening and the air passage define a linear path from outside the housing to the interior of the inner enclosure.

16. The apparatus according to claim 14 wherein the inner enclosure extends about the heating element at the free end thereof and along the heating element from the free end thereof.

17. The apparatus according to claim 8 wherein the heating element is exposed to an exterior environment surrounding the housing along a linear path through the opening in the housing.

18. The apparatus according to claim 8 in combination with the existing smoking device.

19. A volatile material vaporizing device comprising:
a housing comprising an elongate plug portion shaped and sized to allow axial sliding thereof along a longitudinal axis of the housing into a cigarette lighter socket of a vehicle;
electrical connections supported at the plug portion of the housing to define electrical contacts situated externally thereat to establish electrical contact with positive and negative contacts in the cigarette lighter socket under sufficient sliding of the plug portion thereinto;
a heating chamber defined at an end of the housing opposite the plug portion for receiving volatile material to be vaporized by heat from the heating element;
an elongate heating element supported within the housing between the heating chamber and an end of the plug portion thereopposite in electrical communication with the electrical contacts to extend along the longitudinal axis of the housing; and
an inlet opening in the housing and an outlet opening between the housing and the heating chamber defined thereon to allow airflow into the housing through the inlet opening for flow along the heating element into the heating chamber.

20. The device according to claim 19 further comprising a material holder sized and shaped to be removably insertable into the heating chamber to support volatile material therein in fluid communication with the opening between the heating chamber and the housing.
